(19) United States
(12) Patent Application Publication
(10) Pub. No.: US 2003/0215603 A1
(43) Pub. Date: Nov. 20, 2003

(54) Crack arrest tape

(76) Inventor: Wen-Wang Lee, Tao-Yuan City (TW)

Correspondence Address: RABIN & BERDO, P.C., Suite 500, 1101 14th Street, N.W., Washington, DC, 20005, US

(21) Appl. No.: 10/143,971

(22) Filed: May 14, 2002

(51) Int. Cl. B32B 3/10

(52) U.S. Cl. 428/134; 428/131; 428/343

(57) ABSTRACT

A crack arrest tape is in the form of a continuous long strip having a plurality of holes densely distributed on a surface thereof. Elastic patching material serving as a bonding agent in repairing a crack on a wall passes through the holes on the crack arrest tape to hold the latter in place above the crack. Portions on the tape surrounded by any four of the holes adjacent to one another are connecting zones that are at least equal to the holes in area to enhance a structural strength of the crack arrest tape and prevent the tape attached to the crack from displacement and/or tearing due to any deformation stress of the cracked wall resulted from expansion and contraction caused by changes in temperature.

### BACKGROUND OF THE INVENTION

The present invention relates to a crack arrest tape for patching and repairing a crack on a wall, and more particularly to a crack arrest tape made of a polyester fiber material and having holes densely distributed thereon. The holes enable even distribution of deformation stress of the cracked wall resulted from expansion and contraction of the wall caused by changes in temperature, and connecting zones on the tape surrounded by any four of adjacent holes give the crack arrest tape an enhanced structural strength to prevent the tape attached to the cracked wall from easily displacement and/or tearing.

When there is a crack on a wall surface, the crack is usually repaired or patched by cutting off some areas of the wall surrounding the crack and refilling the cut areas with a patching material, such as concrete, and then attaching a crack arrest tape to the patching material. Alternatively, the crack is directly patched with a crack arrest tape.

FIGS. 1 and 2 show a conventional crack arrest tape 1. The tape 1 is usually formed by weaving a plurality warps and wefts made of fiberglass or cotton paper into a long strip having a plurality of square meshes. Each of the warps of the crack arrest tape 1 is formed by twisting a plurality of fine threads together, and the wefts are extended through fine gaps among the threads forming the warps to provide a net-like strip. To use the tape 1 to repair a crack on a wall, the tape 1 is directly attached to the wall over the crack. Then, the patched surface is finished with paint. In another more careful manner of repairing the crack, areas on the wall surrounding the crack is first cut off to provide a recess. The crack arrest tape 1 is adhered to a surface of the recess corresponding to the crack. The recess with the crack arrest tape 1 is then filled with a patching material and finished with paint.

Since the crack arrest tape 1 is an integral piece made of fiberglass or cotton paper for directly attaching to the crack by means of a back adhesive thereof, and the warps and the wefts of the crack arrest tape 1 are not provided with any elastic buffer structure to sustain any external pull or push, the crack arrest tape 1 is subject to deformation or tear when it is stretched or squeezed when the wall is expanded or contracted due to changes in temperature. Such condition occurs because the tape 1 is an integral piece directly attached to the wall and any expansion or contraction stress tends to concentrate at one single small area on the tape 1 instead of being distributed to and absorbed at different portions on the tape 1. The tape 1 is therefore easily displaced or torn when the wall expands or contracts due to changes in temperature. The displaced or torn crack arrest tape 1 results in exposure of the crack again. That is, the tape 1 no longer provides any effect of repairing the crack.

Taiwan New Utility Model Patent Publication No. 376120 discloses an elastic crack arrest tape using metal mesh having good hardness as a main body of the tape in an attempt to solve the above-mentioned problem. However, the metal mesh has inferior ductility. Any folded portion of the metal mesh would increase difficulty in repairing the crack with the elastic crack arrest tape and result in lumpy wall surface. Moreover, the metal mesh increases the cost of the crack arrest tape. Another problem with the elastic crack arrest tape using metal mesh as a main body thereof is the tape and the patching material must be applied at the same time. For a long crack, it must be repaired in several separated sections. It is unacceptable to apply the patching material at one time and apply the elastic crack arrest tape later. This would naturally cause inconveniences to the workers.

It is therefore desirable to develop an improved crack arrest tape to eliminate the drawbacks existing in the conventional crack arrest tapes.

### SUMMARY OF THE INVENTION

A primary object of the present invention is to provide a crack arrest tape woven from a polyester fiber material and having a plurality of through holes densely distributed on a surface thereof. The through holes enable even distribution of deformation stress of the cracked wall due to expansion and contraction of the wall caused by changes in temperature. Moreover, portions on the tape surrounded by any four adjacent through holes serve as connecting zones and have an overall area at least equal to that of the through holes to enhance a structural strength of the crack arrest tape, preventing the tape attached to the cracked wall from displacement or tearing.

To achieve the above and other objects, the crack arrest tape of the present invention is in the form of a continuous long strip woven from polyester fiber material to include a plurality of holes densely distributed on a surface thereof. Elastic patching material serving as a bonding agent in repairing a crack on a wall passes through the holes on the crack arrest tape to hold the latter in place above the crack. Portions on the tape surrounded by any four of the holes adjacent to one another are connecting zones that are at least equal to the holes in area to enhance a structural strength of the crack arrest tape and prevent the tape attached to the crack from displacement and/or tearing due to any deformation stress of the cracked wall resulted from expansion and contraction caused by changes in temperature.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a plan view of a conventional crack arrest tape showing general structure thereof;

FIG. 2 is a fragmentary, enlarged view of FIG. 1;

FIG. 3 shows a crack arrest tape of the present invention is prepared for arresting a crack on a wall;

FIG. 4 is a fragmentary, enlarged plan view of the crack arrest tape of the present invention;

FIG. 5 shows the crack arrest tape of the present invention is attached to a crack on a wall after the crack is filled with a first layer of patching material;

FIG. 6 is a cross sectional view showing a crack on a wall has been repaired with the crack arrest tape of the present invention and two layers of patching material; and

FIG. 7 shows sequences of repairing a crack on a wall with the crack arrest tape of the present invention.

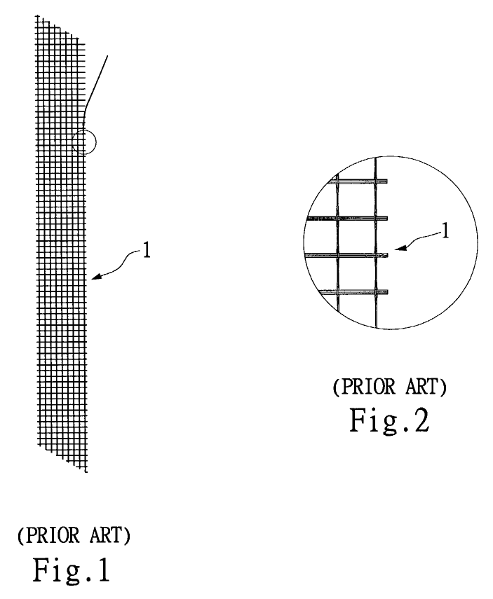

### DETAILED DESCRIPTION OF THE PREFERRED EMBODIMENTS

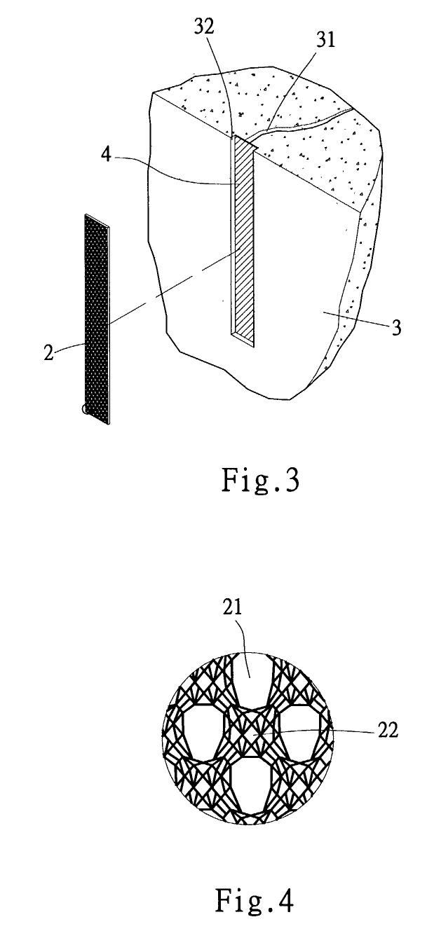

Please refer to FIG. 3 that shows a wall 3 having a crack 31 to be repaired with a crack arrest tape 2 of the present invention. The crack arrest tape 2 is formed by weaving a polyester fiber material into a continuous long strip, such that a surface of which has a plurality of densely distributed round holes 21. Portions on the crack arrest tape 2 surrounded by any four adjacent round holes 21 are connecting zones 22 having an overall area at least equal to that of the round holes 21, as shown in FIG. 4. It is understood the holes 21 are not necessarily round holes but may be of any other geometrical shape. The crack arrest tape 2 is provided at one side with a layer of bonding material as an auxiliary means to adhere the crack arrest tape 2 to the wall 3 for repairing the crack 31.

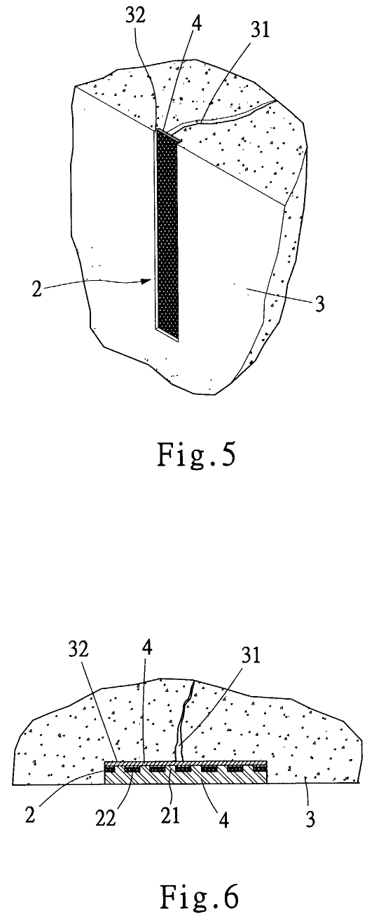

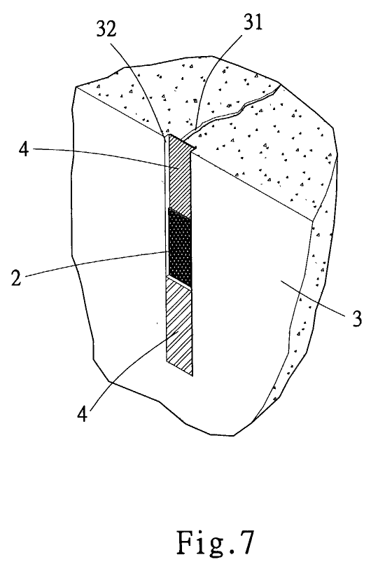

To use the crack arrest tape 2 of the present invention to repair the crack 31 on the wall 3, first cut off areas surrounding the crack 31 to provide a recess 32, as shown in FIG. 3. Then, use an elastic patching material 4 to fill the recess 32. With the elastic patching material 4 as a bonding agent, an adequate length of crack arrest tape 2 is attached to a surface of the patching material 4 in the recess 32, as shown in FIG. 5. Finally, apply another layer of the elastic patching material 4 over the crack arrest tape 2 in the recess 32, so that the recess 32 is flush with the wall surface 3. Thereafter, the patched portion may be finished with paint to provide a beautiful appearance. With the above-described manner of patching, the crack arrest tape 2 is sandwiched between two layers of elastic patching material 4, as shown in FIGS. 6 and 7. As can be best seen from FIG. 6, a part of the elastic patching material 4 passes through the round holes 21 on the crack arrest tape 2 to connect the two layers of elastic patching material 4 into one integral body. In this manner, the crack arrest tape 2 is fixedly bonded to the recess 32 by the two layers of elastic patching material 4 to provide enhanced effect of arresting the crack 31.

The elastic patching material 4 and the connecting zones 22 and the round holes 21 on the crack arrest tape 2 are operative to effectively and evenly distribute and absorb any expansion or contraction stress of the crack 31 due to changes in temperature, and thereby protect the crack arrest tape 2 attached to the cracked wall 3 from displacement or tearing, as well as prevent the crack 31 from exposure to external environment again, so that an effective and endurable repairing of the crack 31 is ensured. The round holes 21 preformed on the crack arrest tape 2 also allow the crack arrest tape 2 to be gas-permeable. Any gas appeared in the wall 3 near the crack 31 at the expansion or contraction thereof could be expelled to external space from the round holes 21 via pores in the elastic patching material 4, and the possibility of a blistered or warped crack arrest tape 2 is therefore eliminated.

The use of the crack arrest tape 2 of the present invention to repair or patch the crack 31 on the wall 3 has the following advantages:

1. The crack arrest tape 2 is made of a polyester fiber material that enables reduction of material cost for the crack arrest tape 2.

2. Each of the connecting zones 22 reserved among any four adjacent holes 21 on the crack arrest tape 2 has an area at least equal to that of the hole 21 to ensure even distribution of deformation stress of the wall 3 due to expansion and contraction caused by changes in temperature. The connecting zones 22 have quantities and an overall area proportional to those of the round holes 21 and are therefore helpful in enhancing the structural strength of the crack arrest tape 2 and preventing the crack arrest tape 2 attached to the crack 31 from displacement and tearing.

3. It is not necessary to apply the elastic patching material 4 and the crack arrest tape 2 at the same time. The bonding material provided at one side of the crack arrest tape 2 allows the tape 2 to be directly attached to the surface of the crack 31 to simplify the repairing of the crack 31.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A crack arrest tape comprising a continuous long strip having a plurality of holes densely distributed over a surface thereof, said holes allowing an amount of elastic patching material filled in a crack on a wall to pass therethrough and thereby bond said crack arrest tape to said crack, and allowing even distribution of deformation stress of said wall due to expansion and contraction caused by changes in temperature; and said crack arrest tape being characterized in that portions on said crack arrest tape surrounded by any four of said holes adjacent to one another serve as connecting zones and have an overall area at least equal to that of said holes; and said connecting zones being proportional to said holes in quantity and area to enhance a structural strength of said crack arrest tape and prevent said crack arrest tape attached to said crack from displacement and tearing.

2. The crack arrest tape as claimed in claim 1, wherein said tape is made of a polyester fiber material.

3. The crack arrest tape as claimed in claim 1, wherein said holes formed on said crack arrest tape are in a geometrical shape.

4. The crack arrest tape as claimed in claim 1, wherein said holes formed on said crack arrest tape are round holes.

5. The crack arrest tape as claimed in claim 1, wherein said connecting zones on said crack arrest tape are larger than said holes in area.

6. The crack arrest tape as claimed in claim 1, wherein said crack arrest tape is provided at one side with a layer of bonding material.
